(19) United States
(12) Patent Application Publication
(10) Pub. No.: US 2012/0215380 A1
(43) Pub. Date: Aug. 23, 2012

(54) SEMI-AUTONOMOUS ROBOT THAT SUPPORTS MULTIPLE MODES OF NAVIGATION

(75) Inventors: Jean Sebastien Fouillade, Redmond, WA (US); Charles F. Olivier, III, Bothell, WA (US); Malek M. Chalabi, Redmond, WA (US); Nathaniel T. Clinton, Sammamish, WA (US); Russ Sanchez, Seattle, WA (US); Chad Aron Voss, Seattle, WA (US)

(73) Assignee: Microsoft Corporation, Redmond, WA (US)

(21) Appl. No.: 13/032,661

(22) Filed: Feb. 23, 2011

(51) Int. Cl. B25J 13/08

(52) U.S. Cl. 701/2

(57) ABSTRACT

Described herein are technologies pertaining to robot navigation. The robot includes a video camera that is configured to transmit a live video feed to a remotely located computing device. A user interacts with the live video feed, and the robot navigates in its environment based upon the user interaction. In a first navigation mode, the user selects a location, and the robot autonomously navigates to the selected location. In a second navigation mode, the user causes the point of view of the video camera on the robot to change, and thereafter causes the robot to semi-autonomously drive in a direction corresponding to the new point of view of the video camera. In a third navigation mode, the user causes the robot to navigate to a selected location in the live video feed.

### BACKGROUND

A “robot”, as the term will be used herein, is an electro-mechanical machine that includes computer hardware and software that causes the robot to perform functions independently and without assistance from a user. An exemplary robot is a droid that can be configured to fly into particular locations without being manned by a pilot. Sensors on the droid can output data that can cause such droid to adjust its flight pattern to ensure that the droid reaches an intended location.

While the droid is generally utilized in military applications, other consumer-level robots have relatively recently been introduced to the market. For example, a vacuum cleaner has been configured with sensors that allow such vacuum cleaner to operate independently and vacuum a particular area, and thereafter automatically return to a charging station. In yet another example, robot lawnmowers have been introduced, wherein an owner of such a robot lawnmower defines a boundary, and the robot lawnmower proceeds to cut grass in an automated fashion based upon the defined boundary.

Additionally, technologies have enabled some robots to be controlled or given instructions from remote locations. In other words, the robot can be in communication with a computing device that is remote from the robot, wherein the robot and the computing device are in communication by way of a network. Oftentimes, and particularly for military applications, these networks are proprietary. Accordingly, an operator of the robot need not be concerned with deficiencies corresponding to most networks, such as network latencies, high network traffic, etc. Currently available robots that can be operated or controlled in a telepresence mode do not sufficiently take into consideration these aforementioned network deficiencies.

### SUMMARY

The following is a brief summary of subject matter that is described in greater detail herein. This summary is not intended to be limiting as to the scope of the claims.

Described herein is a robot that can be controlled via an application executing on a remotely situated computing device, wherein the robot supports at least three different navigation modes. The robot is mobile such that it can travel from a first location to a second location, and the robot has a video camera therein and can transmit a live video feed to the remote computing device by way of a network connection. The remote computing device can display this live video feed to a user, and the user, for instance, can control operations of the robot based at least in part upon interaction with this live video feed.

As mentioned above, three different navigation modes can be supported by the robot. A first mode of navigation can be referred to herein as a “direct and drive” navigation mode. In this navigation mode, the user can select, via a mouse, gesture, touch etc., a particular position in the video feed that is received from the robot. Responsive to receiving this selection from the user, the remote computing device can transmit a command to the robot, wherein such command can include coordinates of the selection of the user in the video feed. The robot can translate these coordinates into a coordinate system that corresponds to the environment of the robot, and the robot can thereafter compare such coordinates with a current orientation (point of view) of the video camera. Based at least in part upon this comparison, the robot causes the point of view of the video camera to change from a first point of view (the current point of view) to a second point of view, wherein the second point of view corresponds to the user selection of the location in the video feed.

The robot can continue to transmit a live video feed to the user, and when the live video feed is at a point of view (orientation) that meets the desires of the user, the user can provide a command to the remote computing device to cause the robot to drive forward in the direction that corresponds to this new point of view. The remote computing device transmits this command to the robot and the robot orients its body in the direction corresponding to the point of view of the video camera. Thereafter, the robot begins to drive in the direction that corresponds to the point of view of the video camera in a semi-autonomous manner. For instance, the user can press a graphical button on the remote computing device to cause the robot continue to travel forward. For instance, the remote computing device can transmit “heartbeats” to the robot that indicate that the robot is to continue to drive forward, wherein a heartbeat is a data packet that can be recognized by the robot as a command to continue to drive forward. If the heartbeat is not received by the robot, either because the user wishes that the robot cease to drive forward or there is a break in the network connection between the robot and the remote computing device, the robot will stop moving.

If the robot, when traveling in the direction that corresponds to the point of view of the video camera, senses an obstacle, the robot can automatically change its direction of travel to avoid such obstacle. Once the obstacle is avoided, the robot can continue to travel in the direction that corresponds to the point of view of the camera. In “direct and drive” navigation mode, the user can cause the robot to explore its environment while sending the robot a relatively small number of commands.

Another exemplary navigation mode that is supported by the robot can be referred to herein as “location direct” mode. The “location direct” navigation mode relates to causing the robot to autonomously travel to a particular tagged location or to a specified position on a map. Pursuant to an example, the robot can have a map retained in memory thereof, wherein the map can be defined by a user or learned by the robot through exploration of the environment of the robot. That is, the robot can learn boundaries, locations of objects, etc. through exploration of an environment and monitoring of sensors, such as depth sensors, video camera(s), etc. The map can be transmitted from the robot to the remote computing device, and, for instance, the user can tag locations in the map. For example, the map may be of several rooms of a house, and the user can tag the rooms with particular identities such as “kitchen”, “living room”, “dining room”, etc. More granular tags can also be applied such that the user can indicate a location of a table, a sofa, etc. in the map.

Once the user has tagged desired locations in the map (either locally at the robotic device or remotely), the user can select a tag via a graphical user interface, which can cause the robot to travel to the tagged location. Specifically, selection of a tag in the map can cause the remote computing device to transmit coordinates to the robot (coordinates associated with the tagged location), which can interpret the coordinates or translate the coordinates to a coordinate system that corresponds to the environment of the robot. The robot can be aware of its current location with respect to the map through, for instance, a location sensor such as a GPS sensor, through analysis of its environment, through retention and analysis of sensor data over time, etc. For example, through exploration, the robot can have knowledge of a current position/orientation thereof and, based upon the current position/orientation, the robot can autonomously travel to the tagged location selected by the user. In another embodiment, the user can select an untagged location in the map, and the robot can autonomously travel to the selected location.

The robot has several sensors thereon they can be used, for instance, to detect obstacles in the path of the robot, and the robot can autonomously avoid such obstacles when traveling to the selected location in the map. Meanwhile, the robot can continue to transmit a live video feed to the remote computer, such that the user can “see” what the robot is seeing. Accordingly, the user can provide a single command to cause the robot to travel to a desired location.

A third navigation mode that can be supported by the robot can be referred to herein as a “drag and direct” mode. In such a navigation mode, the robot can transmit a live video feed that is captured from a video camera on the robot. A user at the remote computer can be provided with a live video feed, and can utilize a mouse, a gesture, a finger, etc. to select the live video feed, and make a dragging motion across the live video feed. The selection and dragging of the live video feed can result in data being transmitted to the robot that causes the robot to alter the point of view of the camera at a speed and direction that corresponds to the dragging of the video feed by the user. If the video camera cannot be moved at a speed that corresponds to the speed of the drag of the video feed of the user, then the remote computer can alter the video feed presented to the individual to “gray-out” areas of the video feed that have not yet been reached by the video camera, and the grayed out area will be filled in by what is captured by the video camera as the robot is able to alter the position of the video camera to the point of view that corresponds to the desired point of view of the video camera. This allows the user to view a surrounding environment of the robot relatively quickly (e.g. as fast as the robot can change the position of the video camera).

Additionally, in this navigation mode, the user can hover a mouse pointer or a finger over a particular portion of the video feed that is received from the robot. Upon the detection of a hover, an application executing on the remote computer can cause a graphical three-dimensional indication to be displayed that corresponds to a particular physical location in the video feed. The user may then select a particular position in the video feed, which causes the robot to autonomously drive to that position through utilization of, for example, sensor data captured on the robot. The robot can autonomously avoid obstacles while traveling to the selected location in the video feed.

Other aspects will be appreciated upon reading and understanding the attached figures and description.

### BRIEF DESCRIPTION OF THE DRAWINGS

FIG. 1 illustrates exemplary hardware of a robot.

FIG. 2 illustrates an exemplary network environment where a robot can be controlled from a remote computing device.

FIG. 3 is a functional block diagram of an exemplary robot.

FIG. 4 is a functional block diagram of an exemplary remote computing device that can be utilized in connection with providing navigation commands to a robot.

FIGS. 5-11 are exemplary graphical user interfaces that can be utilized in connection with providing navigation commands to a robot.

FIG. 12 is a flow diagram that illustrates an exemplary methodology for causing a robot to drive in a semi-autonomous manner in a particular direction.

FIG. 13 is a flow diagram that illustrates exemplary methodology for causing a robot to drive in a particular direction.

FIG. 14 is a control flow diagram that illustrates actions of a user, a remote computing device, and a robot in connection with causing the robot to travel to a particular location on a map.

FIG. 15 as an exemplary control flow diagram that illustrates communications/actions undertaken by a user, a remote computing device, and a robot in connection with causing the robot to drive in a particular direction.

FIG. 16 is an exemplary control flow diagram that illustrates communications and actions undertaken by a user, a remote computing device, and a robot in connection with causing the robot to drive to a particular location.

FIG. 17 illustrates an exemplary computing system.

### DETAILED DESCRIPTION

Various technologies pertaining to robot navigation in a telepresence environment will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

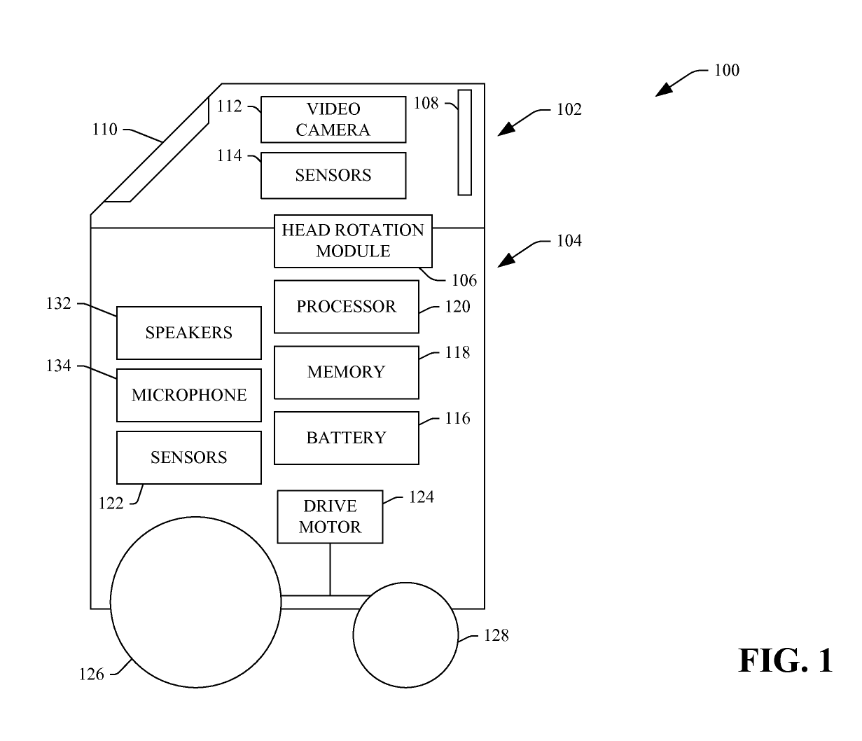

With reference to FIG. 1, an exemplary robot 100 that can communicate with a remotely located computing device by way of a network connection is illustrated. The robot 100 comprises a head portion 102 and a body portion 104, wherein the head portion 102 is movable with respect to the body portion 104. The robot 100 can comprise a head rotation module 106 that operates to couple the head portion 102 with the body portion 104, wherein the head rotation module 106 can include one or more motors that can cause the head portion 102 to rotate with respect to the body portion 104. Pursuant to an example, the head rotation module 106 can be utilized to rotate the head portion 102 with respect to the body portion 104 up to 45° in any direction. In another example, the head rotation module 106 can allow the head portion 102 to rotate 90° in relation to the body portion 104. In still yet another example, the head rotation module 106 can facilitate rotation of the head portion 102 180° with respect to the body portion 104. The head rotation module 106 can facilitate rotation of the head portion 102 with respect to the body portion 102 in either angular direction.

The head portion 102 may comprise an antenna 108 that is configured to receive and transmit wireless signals. For instance, the antenna 108 can be configured to receive and transmit Wi-Fi signals, Bluetooth signals, infrared (IR) signals, sonar signals, radio frequency (RF), signals or other suitable signals. In yet another example, the antenna 108 can be configured to receive and transmit data to and from a cellular tower. The robot 100 can send and receive communications with a remotely located computing device through utilization of the antenna 108.

The head portion 102 of the robot 100 can also comprise a display 110 is that is configured to display data to an individual that is proximate to the robot 100. For example, the display 110 can be configured to display navigational status updates to a user. In another example, the display 110 can be configured to display images that are transmitted to the robot 100 by way of the remote computer. In still yet another example, the display 110 can be utilized to display images that are captured by one or more cameras that are resident upon the robot 100.

The head portion 102 of the robot 100 may also comprise a video camera 112 that is configured to capture video of an environment of the robot. In an example, the video camera 112 can be a high definition video camera that facilitates capturing video data that is in, for instance, 720p format, 720i format, 1080p format, 1080i format, or other suitable high definition video format. Additionally or alternatively, the video camera 112 can be configured to capture relatively low resolution data is in a format that is suitable for transmission to the remote computing device by way of the antenna 108. As the video camera 112 is mounted in the head portion 102 of the robot 100, through utilization of the head rotation module 106, the video camera 112 can be configured to capture live video data of a relatively large portion of an environment of the robot 100.

The robot 100 may further comprise one or more sensors 114, wherein such sensors 114 may be or include any suitable sensor type that can aid the robot 100 in performing autonomous navigation. For example, these sensors 114 may comprise a depth sensor, an infrared sensor, a camera, a cliff sensor that is configured to detect a drop-off in elevation proximate to the robot 100, a GPS sensor, an accelerometer, a gyroscope, or other suitable sensor type.

The body torsion 104 of the robot 100 may comprise a battery 116 that is operable to provide power to other modules in the robot 100. The battery 116 may be for instance, a rechargeable battery. In such a case, the robot 100 may comprise an interface that allows the robot 100 to be coupled to a power source, such that the battery 116 can be relatively easily provided with an electric charge.

The body portion 104 of the robot 100 can also comprise a memory. 118 and a corresponding processor 120. As will be described in greater detail below, the memory 118 can comprise a plurality of components that are executable by the processor 120, wherein execution of such components facilitates controlling one or more modules of the robot. The processor 120 can be in communication with other modules in the robot 100 by way of any suitable interface such as, for instance, a motherboard. It is to be understood that the processor 120 is the “brains” of the robot 100, and is utilized to process data received from the remote computer, as well as other modules in the robot 100 to cause the robot 100 to perform in a manner that a desired by a user of such robot 100.

The body portion 104 of the robot 100 can further comprise one or more sensors 122, wherein such sensors 122 can include any suitable sensor that can output data they can be utilized in connection with autonomous or semi-autonomous navigation. For example, the sensors 122 may be or include sonar sensors, location sensors, infrared sensors, a camera, a cliff sensor, and/or the like. Data that is captured by the sensors 122 and the sensors 114 can be provided to the processor 120, which can process such data and autonomously navigate the robot 100 based at least in part upon data output by the sensors 114 and 122.

The body portion 104 of the robot 100 may further comprise a drive motor 124 that is operable to drive wheels 126 and/or 128 of the robot 100. For example, the wheel 126 can be a driving wheel while the wheel 128 can be a steering wheel that can act to pivot to change the orientation of the robot 100. Additionally, each of the wheels 126 and 128 can have a steering mechanism corresponding thereto, such that the wheels 126 and 128 can contribute to the change in orientation of the robot 100. Furthermore, while the drive motor 124 is shown as driving both of the wheels 126 and 128, it is to be understood that the drive motor 124 may drive only one of the wheels 126 or 128 while another drive motor can drive the other of the wheels 126 or 128. Upon receipt of data from the sensors 114 and 122 and/or receipt of commands from the remote computing device (received by way of the antenna 108), the processor 120 can transmit signals to the head rotation module 106 and/or the drive motor 124 to control orientation of the head portion 102 with respect to the body portion 104 of the robot 100 and/or orientation and position of the robot 100.

The body portion 104 of the robot 100 can further comprise speakers 132, and a microphone 134. Data captured by way of the microphone 134 can be transmitted to the remote computing device by way of the antenna 108. Accordingly, a user at the remote computing device can receive a real-time audio/video feed and can experience the environment of the robot 100. The speakers 132 can be employed to output audio data to one or more individuals that are proximate to the robot 100. This audio information can be a multimedia file that is retained in the memory 118 of the robot 100, audio files received by the robot 100 from the remote computing device by way of the antenna 108, real-time audio data from a web-cam or microphone at the remote computing device, etc.

While the robot 100 has been shown in a particular configuration and with particular modules included therein it is to be understood that the robot can be configured in a variety of different manners, and these configurations are contemplated by the inventors and are intended to fall within the scope of the hereto-appended claims. For instance, the head rotation module 106 can be configured with a tilt motor so that the head portion 102 of the robot 100 can not only rotate with respect to the body portion 104 but can also tilt in a vertical direction. Alternatively, the robot 100 may not include two separate portions, but may include a single unified body, wherein the robot body can be turned to allow the capture of video data by way of the video camera 112. In still yet another exemplary embodiment, the robot 100 can have a unified body structure, but the video camera 112 can have a motor, such as a servomotor, associated therewith that allows the video camera 112 to alter position to obtain different views of an environment. Still further, modules that are shown to be in the body portion 104 can be placed in the head portion 102 of the robot 100, and vice versa. It is also to be understood that the robot 100 has been provided solely for the purposes of explanation and is not intended to be limiting as to the scope of the hereto-appended claims.

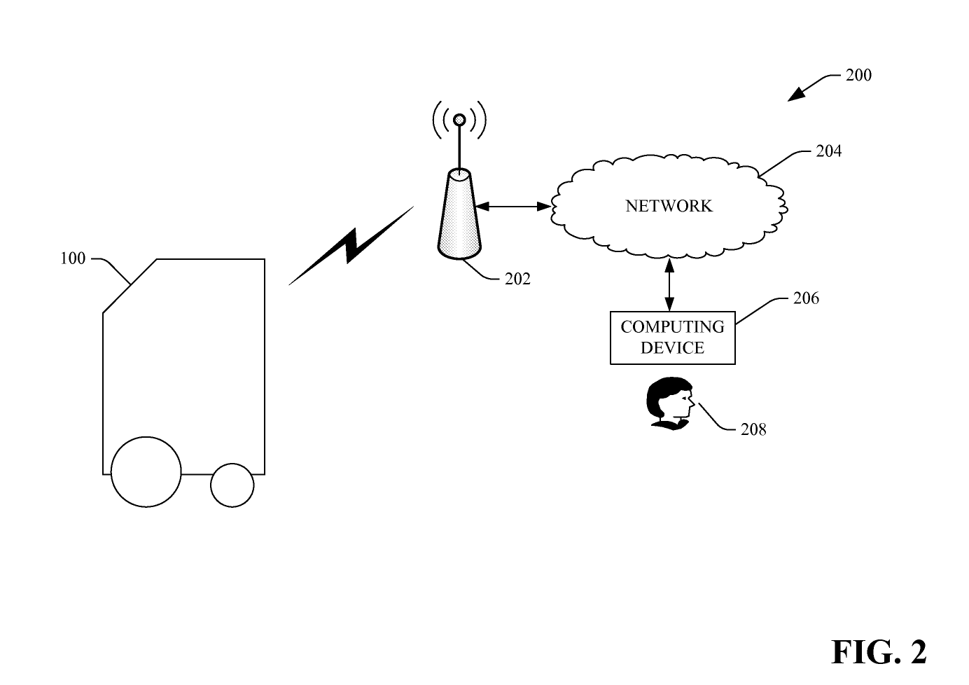

With reference now to FIG. 2, an exemplary computing environment 200 that facilitates remote transmission of commands to the robot 100 is illustrated. As described above, the robot 100 can comprise the antenna 108 that is configured to receive and transmit data wirelessly. In an exemplary embodiment, when the robot 100 is powered on, the robot 100 can communicate with a wireless access point 202 to establish its presence with such access point 202. The robot 100 may then obtain a connection to a network 204 by way of the access point 202. For instance, the network 204 may be a cellular network, the Internet, a proprietary network such as an intranet, or other suitable network.

A computing device 206 can have an application executing thereon that facilitates communicating with the robot 100 by way of the network 204. For example, and as will be understood by one of ordinary skill in the art, a communication channel can be established between the computing device 206 and the robot 100 by way of the network 204 through various actions such as handshaking, authentication, etc. The computing device 206 may be a desktop computer, a laptop computer, a mobile telephone, a mobile multimedia device, a gaming console, or other suitable computing device. While not shown, the computing device 206 can include or have associated therewith a display screen they can present data to a user 208 pertaining to navigation of the robot 100. For instance, as described above, the robot 100 can transmit a live audio/video feed to the remote computing device 206 by way of the network 204, and the computing device 206 can present this audio/video feed to the user 208. As will be described below, the user 208 can transmit navigation commands to the robot 100 by way of the computing device 206 over the network 204.

In an exemplary embodiment, the user 208 and the computing device 206 may be in a remote location from the robot 100, and the user 208 can utilize the robot 100 to explore an environment of the robot 100. Exemplary applications where the user 208 may wish to control such robot 208 remotely include a teleconference or telepresence scenario where the user 208 can present data to others that are in a different location from the user 208. In such case, the user 208 can additionally be presented with data from others that are in the different location. In another exemplary application, the robot 100 may be utilized by a caretaker to communicate with a remote patient for medical purposes. For example, the robot 100 can be utilized to provide a physician with a view of an environment where a patient is residing, and can communicate with such patient by way of the robot 100. Other applications where utilization of a telepresence session is desirable are contemplated by the inventors and are intended to fall within the scope of the hereto-appended claims.

In another exemplary embodiment, the robot 100 may be in the same environment as the user 208. In such an embodiment, authentication can be undertaken over the network 204, and thereafter the robot 100 can receive commands over a local access network that includes the access point 202. This can reduce deficiencies corresponding to the network 204, such as network latency.

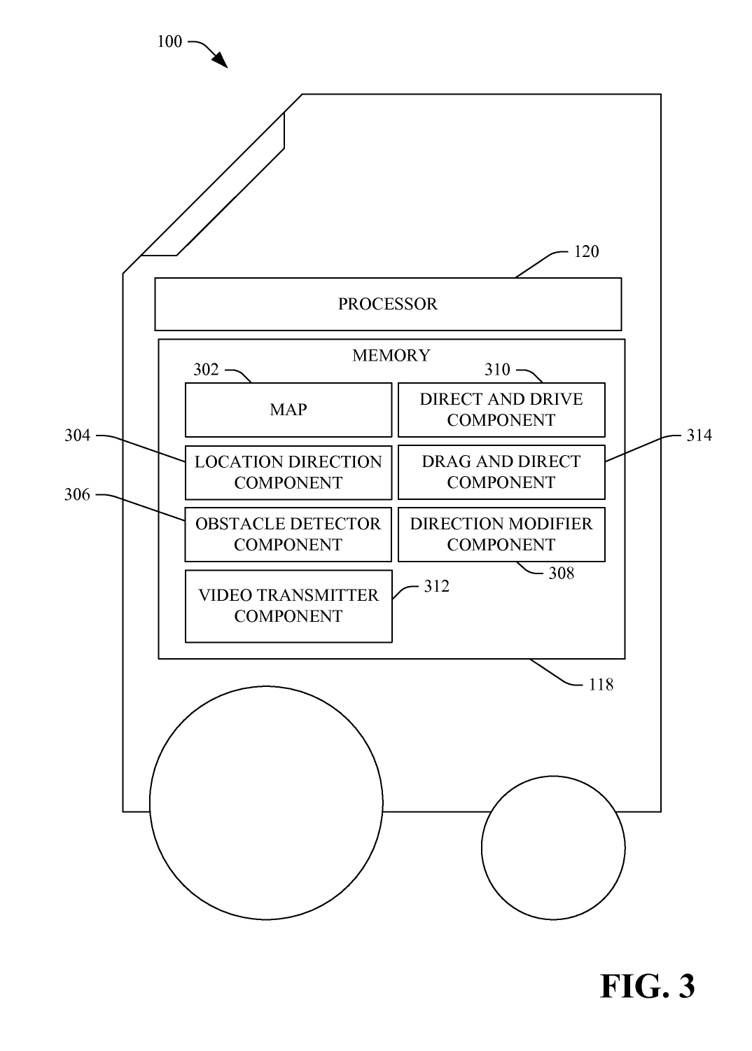

With reference now to FIG. 3, an exemplary depiction of the robot 100 is illustrated. As described above, the robot 100 comprises the processor 120 and the memory 118. The memory 118 comprises a plurality of components that are executable by the processor 120, wherein such components are configured to provide a plurality of different navigation modes for the robot 100. The navigation modes that are supported by the robot 100 include what can be referred to herein as a “location direct” navigation mode, a “direct and drive” navigation mode, and a “drag and direct” navigation mode. The components in the memory 118 that support these modes of navigation will now be described.

The memory 118 may comprise a map 302 of an environment of the robot 100. This map 302 can be defined by a user such that the map 302 indicates location of certain objects, rooms, and/or the like in the environment. Alternatively, the map 302 can be automatically generated by the robot 100 through exploration of the environment. In a particular embodiment, the robot 100 can transmit the map 302 to the remote computing device 206, and the user 208 can assign tags to locations in the map 302 at the remote computing device 206. As will be shown herein, the user 208 can be provided with a graphical user interface that includes a depiction of the map 302 and/or a list of tagged locations, and the user can select a tagged location in the map 302. Alternatively, the user 208 can select an untagged location in the map 302.

The memory 118 may comprise a location direction component 304 that receives a selection of a tagged or untagged location in the map 302 from the user 208. The location direction component 304 can treat the selected location as a node, and can compute a path from a current position of the robot 100 to the node. For instance, the map 302 can be interpreted by the robot 100 as a plurality of different nodes, and the location direction component 304 can compute a path from a current position of the robot 100 to the node, wherein such path is through multiple nodes. In an alternative embodiment, the location direction component can receive the selection of the tagged or untagged location in the map and translate coordinates corresponding to the selection to coordinates corresponding to the environment of the robot 100 (e.g., the robot 100 has a concept of coordinates on a floor plan). The location direction component 304 can then cause the robot 100 to travel to the selected location. With more specificity, the location direction component 304 can receive a command from the computing device 206, wherein the command comprises an indication of a selection by the user 208 of a tagged or untagged location in the map 302. The location direction component 304, when executed by the processor 120, can cause the robot 100 to travel from a current position in the environment to the location in the environment that corresponds to the selected location in the map 302.

As the robot 100 is traveling towards the selected location, one or more obstacles may be in a path that is between the robot 100 and the selected location. The memory 118 can comprise an obstacle detector component 306 that, when executed by the processor 120, is configured to analyze data received from the sensors 114 and/or the sensors 122 and detect such obstacles. Upon detecting an obstacle in the path of the robot 100 between the current position of the robot 100 and the selected location, the obstacle detector component 306 can output an indication that such obstacle exists as well as an approximate location of the obstacle with respect to the current position of the robot 100. A direction modifier component 308 can receive this indication and, responsive to receipt of the indication of the existence of the obstacle, the direction modifier component 208 can cause the robot 100 to alter its course (direction) from its current direction of travel to a different direction of travel to avoid the obstacle. The location direction component 304 can thus be utilized in connection with autonomously driving the robot 100 to the location in the environment that was selected by the user 208 through a single mouse-click by the user 208, for example.

The memory 118 may also comprise a direct and drive component 310 that supports the “direct and drive” navigation mode. As described previously, the robot 100 may comprise the video camera 112 that can transmit a live video feed to the remote computing device 206, and the user 208 of the remote computing device 206 can be provided with this live video feed in a graphical user interface. With more specificity, the memory 118 can comprise a video transmitter component 312 that is configured to receive a live video feed from the video camera 112, and cause the live video feed to be transmitted from the robot 100 to the remote computing device 206 by way of the antenna 108. Additionally, the video transmitter component 312 can be configured to cause a live audio feed to be transmitted to the remote computing device 206. The user 208 can select a portion of the live video feed is being presented to such user 208, and the selection of this portion of the live video feed can be transmitted back to the robot 100.

The user can select the portion of the live video feed through utilization of a mouse, a gesture, touching a touch sensitive display screen etc. The direct and drive component 310 can receive the selection of a particular portion of the live video feed. For instance, the selection may be in the form of coordinates on the graphical user interface of the remote computing device 206, and the direct and drive component 310 can translate such coordinates into a coordinate system that corresponds to the environment of the robot 100. The direct and drive 310 can compare the coordinates corresponding to the selection of the live video feed received from the remote computing device 206 with a current position/point of view of the video camera 112. If there is a difference in such coordinates, the direct and drive component 310 can cause a point of view of the video camera 112 to be changed from a first point of view (the current point of view of the video camera 112) to a second point of view, wherein the second point of view corresponds to the location in the live video feed selected by the user 208 at the remote computing device 206. For instance, the direct and drive component 310 can be in communication with the head rotation module 106 such that the direct and drive component 310 can cause the head rotation module 106 to rotate and or tilt the head portion 102 of the robot 100 such that the point of view of the video camera 112 corresponds to the selection made by the user 208 at the remote computing device 206.

The video transmitter component 312 causes the live video feed to be continuously transmitted to the remote computing device 206—thus, the user 208 can be provided with the updated video feed as the point of view of the video camera 112 is changed. Once the video camera 112 is facing a direction or has a point of view that is desired by the user 208, the user 208 can issue another command that indicates the desire of the user for the robot 100 to travel in a direction that corresponds to the current point of view of the video camera 112. In other words, the user 208 can request that the robot 100 drive forward from the perspective of the video camera 112. The direct and drive component 310 can receive this command and can cause the drive motor 124 to orient the robot 100 in the direction of the updated point of view of the video camera 112. Thereafter, the direct and drive component 310, when being executed by the processor 120, can cause the drive motor 124 to drive the robot 100 in the direction that has been indicated by the user 208.

The robot 100 can continue to drive or travel in this direction until the user 208 indicates that she wishes that the robot 100 cease traveling in such direction. In another example, the robot 100 can continue to travel in this direction unless and until a network connection between the robot 100 and the remote computing device 206 is lost. Additionally or alternatively, the robot 100 can continue traveling in the direction indicated by the user until the obstacle detector component 306 detects an obstacle that is in the path of the robot 100. Again, the obstacle detector component 306 can process data from the sensors 114 and/or 122, and can output an indication that the robot 100 will be unable to continue traveling in the current direction of travel. The direction modifier component 308 can receive this indication and can cause the robot 100 to travel in a different direction to avoid the obstacle. Once the obstacle detector component 306 has detected that the obstacle has been avoided, the obstacle detector component 306 can output an indication to the direct and drive component 310, which can cause the robot 100 to continue to travel in a direction that corresponds to the point of view of the video camera 112.

In a first example, the direct and drive component 310 can cause the robot 100 to travel in the direction such that the path is parallel to the original path that the robot 100 took in accordance with commands output by the direct and drive component 310. In a second example, the direct and drive component 310 can cause the robot 100 to encircle around the obstacle and continue along the same path of travel as before. In a third example, the direct and drive component 310 can cause the robot 100 to adjust its course to avoid the obstacle (such that the robot 100 is travelling over a new path), and after the obstacle has been avoided, the direct and drive component 310 can cause the robot to continue to travel along the new path. Accordingly, if the user desires that the robot 100 continue along an original heading, the user can stop driving the robot 100 and readjust the heading.

The memory 118 also comprises a drag and direct component 314 that is configured to support the aforementioned “drag and direct” mode. In such mode, the video transmitter component 312 transmits a live video feed from the robot 100 to the remote computing device 206. The user 208 reviews the live video feed and utilizes a mouse, a gesture, etc. to select the live video feed and make a dragging motion across the live video feed. The remote computing device 206 transmits data to the robot 100 that indicates that the user 208 is making such dragging motion over the live video feed. The drag and direct component 314 receives this data from the remote computing device 206 and translates the data into coordinates corresponding to the point of view of the robot 100. Based at least in part upon such coordinates, the drag and direct component 314 causes the video camera 112 to change its point of view corresponding to the dragging action of the user 208 at the remote computing device 206. Accordingly, by dragging the mouse pointer, for instance, across the live video feed displayed to the user 208, the user 208 can cause the video camera 112 to change its point of view, and therefore allows the user 208 to visually explore the environment of the robot 100.

As mentioned previously, so long as a network connection exists between the robot 100 and the remote computing device 206, the video transmitter component 312 can be configured to transmit a live video feed captured at the robot 100 to the remote computing device 206. The user 208, when the “drag and direct” navigation mode is employed, can hover a mouse pointer, for instance, over a particular portion of the live video feed presented to the user at the remote computing device 206. Based upon the location of the hover in the live video feed, a three-dimensional graphical “spot” can be presented in the video feed to the user 208, wherein such “spot” indicates a location where the user 208 can direct the robot 100. Selection of such location causes the remote computing device 206 to transmit location data to the robot 100 (e.g., in the form of coordinates), which is received by the drag and direct component 314. The drag and direct component 314, upon receipt of this data, can translate the data into coordinates of the floorspace in the environment of the robot 100, and can cause the robot 100 to travel to the location that was selected by the user 208. The robot 100 can travel to this location in an autonomous manner after receiving the command from the user 208. For instance, the obstacle detector component 306 can detect an obstacle based at least in part upon data received from the sensors 114 and/or the sensors 122, and can output an indication of the existence of the obstacle in the path being taken by the robot 100. The direction modifier component 308 can receive this indication and can cause the robot 100 to autonomously avoid the obstacle and continue to travel to the location that was selected by the user 208.

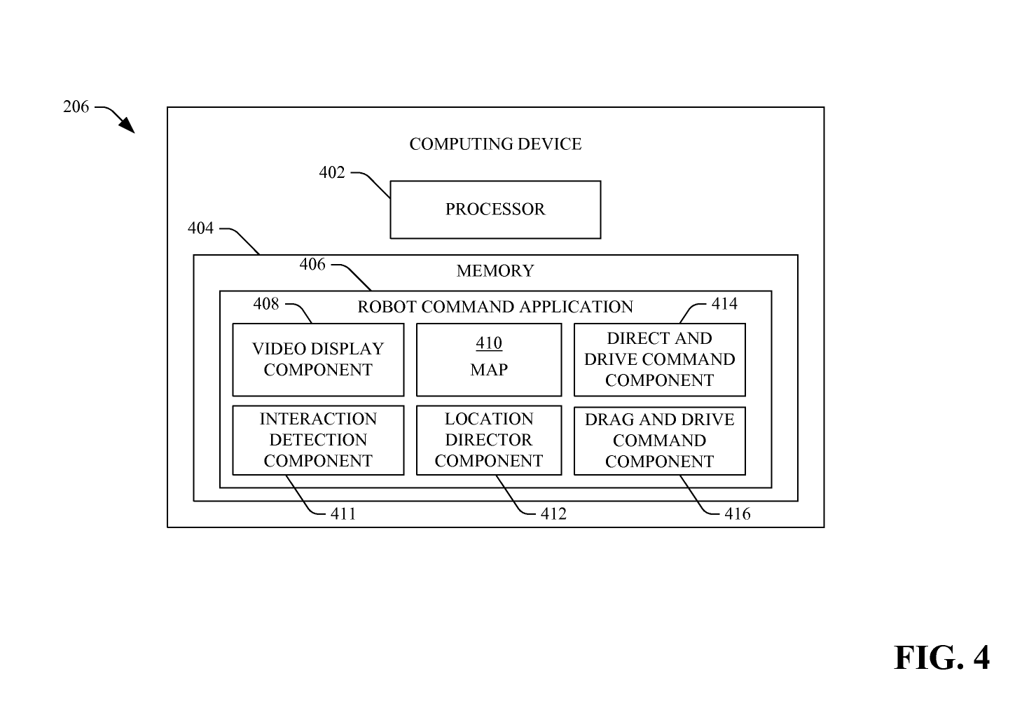

Referring now to FIG. 4, an exemplary depiction 400 of the remote computing device 206 is illustrated. The remote computing device 206 comprises a processor 402 and a memory 404 that is accessible to the processor 402. The memory 404 comprises a plurality of components that are executable by the processor 402. Specifically, the memory 404 comprises a robot command application 406 that can be executed by the processor 402 at the remote computing device 206. In an example, initiation of the robot command application 406 at the remote computing device 206 can cause a telepresence session to be initiated with the robot 100. For instance, the robot command application 406 can transmit a command by way of the network connection to cause the robot 100 to power up. Additionally or alternatively, initiation of the robot command application 406 at the remote computing device 206 can cause an authentication procedure to be undertaken, wherein the remote computing device 206 and/or the user 208 of the remote computing device 206 is authorized to command the robot 100.

The robot command application 406 is configured to facilitate the three navigation modes described above. Again, these navigation modes include the “location direct” navigation mode, the “direct and drive” navigation mode, and the “drag and drive” navigation mode. To support these navigation modes, the robot command application 406 comprises a video display component 408 that receives a live video feed from the robot 100 and displays the live video feed on a display corresponding to the remote computing device 206. Thus, the user 208 is provided with a real-time live video feed of the environment of the robot 100. Furthermore, as described above, the video display component 408 can facilitate user interaction with the live video feed presented to the user 208.

The robot command application 406 can include a map 410, which is a map of the environment of the robot 100. The map can be a two-dimensional map of the environment of the robot, a set of nodes and paths that depict the environment of the robot 100, or the like. This map 410 can be predefined for a particular environment or can be presented to the remote computing device 206 from the robot 100 upon the robot 100 exploring the environment. The user 208 at the remote computing device 206 can tag particular locations in the map 410 such that the map 410 will include indications of locations that the user 208 wishes the robot 100 to travel towards. Pursuant to an example, the list of tagged locations and/or the map 410 itself can be presented to the user 208. The user 208 may then select one of the tagged locations in the map 410 or select a particular untagged position in the map 410. An interaction detection component 411 can detect user interaction with respect to the live video feed presented by the video display component 408. Accordingly, the interaction detection component 411 can detect that the user 208 has selected a tagged location in the map 410 or a particular untagged position in the map 410.

The robot command application 406 further comprises a location director component 412 that can receive the user selection of the tagged location or the position in the map 410 as detected by the interaction detection component 411. The location director component 412 can convert this selection into map coordinates and can provide such coordinates to the robot 100 by way of a suitable network connection. This data can cause the robot 100 to autonomously travel to the selected tagged location or the location in the environment corresponding to the position in the map 410 selected by the user 208.

The robot command application 406 can further comprise a direct and drive command component 414 that supports the “direct and drive” navigation mode described above. For example, the video display component 408 can present the live video feed captured by the video camera 112 on the robot 100 to the user 208. At a first point in time the live video feed can be presented to the user at a first point of view. The user 208 may then select a position in the live video feed presented by the video display component 408, and the interaction detection component 411 can detect the selection of such position. The interaction detection component 411 can indicate that the position has been selected by the user 208, and the direct and drive command component 414 can this selection and can transmit a first command to the robot 100 indicating that the user 208 desires that the point of view of the video camera 112 be altered from the first point of view to a second point of view, wherein the second point of view corresponds to the location in the video feed selected by the user 208. As the point of view of the video camera 112 changes, the video display component 408 can continue to display live video data to the user 208.

Once the point of view of the video feed is at the point of view that is desired by the user 208, the user 208 can indicate that she wishes that the robot 100 to drive forward (in the direction that corresponds to the current point of view of the live video feed). For example, the user 208 can depress a button on a graphical user and interface that indicates the desire of the user 208 for the robot 100 to travel forward (in a direction that corresponds to the current point of view of the live video feed). Accordingly, the direct and drive command component 414 can output a second command over the network that is received by the robot 100, wherein the second command is configured to cause the robot 100 to alter the orientation of its body to match the point of view of the video feed and then drive forward in that direction. The direct and drive command component 414 can be configured to transmit “heartbeats” (bits of data) that indicate that the user 208 wishes for the robot 100 to continue driving in the forward direction. If the user 208 wishes that the robot 100 cease driving forward, the user 208 can release the drive button and the direct and drive command component 414 will cease sending “heartbeats” to the robot 100. This can cause the robot 100 to cease traveling in the forward direction. Additionally, as described above, the robot 100 can autonomously travel in that direction such that obstacles are avoided.

The robot command application 406 can further comprise a drag and drive command component 416 that supports the “drag and drive” navigation mode described above. In an example, the video display component 408 can present the user 208 with a live video feed from the video camera 112 on the robot 100. The user 208 can choose to drag the live video feed in a direction that is desired by the user 208, and such selection and dragging can be detected by the interaction detection component 411. In other words, the user 208 may wish to cause the head portion 102 of the robot 100 to alter its position such that the user 208 can visually explore the environment of the robot 100. Subsequent to the interaction detection component 411 detecting the dragging of the live video feed, the interaction detection component 411 can output data to the drag and drive command component 416 that indicates that the user 208 is interacting with the video presented to the user 208 by the video display component 408.

The drag and drive command component 416 can output a command to the robot 100 that indicates the desire of the user 208 to move the point of view of the video camera 112 at a speed corresponding to the speed of the drag of the live video feed. It can be understood that the user 208 may wish to cause the point of view of the video camera 112 to change faster than the point of view of the video camera 112 is physically able to change. In such a case, the video display component 408 can modify the video being presented to the user such that portions of the video feed are “grayed out,” thereby providing the user 208 with the visual experience of the dragging of the video feed at the speed desired by the user 208. If the robot 100 is unable to turn the video camera 112 or reposition the video camera 112 in the manner desired by the user 208, the robot 100 can be configured to output data that indicates the inability of the video camera 112 to be repositioned as desired by the user 208, and the video display component 408 can display such error to the user 208.

Once the video camera 112 is capturing a portion of the environment that is of interest to the user 208, the user 208 can hover over a portion of the live video feed presented to the user 208 by the video display component 408. The interaction detection component 411 can detect such hover activity and can communicate with the video display component 408 to cause the video display component 408 to include a graphical indicia (spot) on the video feed that indicates a floor position in the field of view of the video camera 112. This graphical indicia can indicate depth of a position to the user 208 in the video feed. Specifically, when the cursor is hovered over the live video feed, a three-dimensional spot at the location of the cursor can be projected onto the floor plane of the video feed by the video display component 408. The video display component 408 can calculate the floor plane using, for instance, the current camera pitch and height. As the user 208 alters the position of the cursor, the three-dimensional spot can update in scale and perspective to show the user where the robot 100 will be directed if such spot is selected by the user 208. Once the user 208 has selected a desired location, the user 208 can select that location on the live video feed. The drag and drive command component 416 can receive an indication of such selection from the interaction detection component 411, and can output a command to the robot 100 to cause the robot 100 to orient itself towards that chosen location and drive to that location. As described above, the robot 100 can autonomously drive to that location such that obstacles can be avoided in route to the desired location.

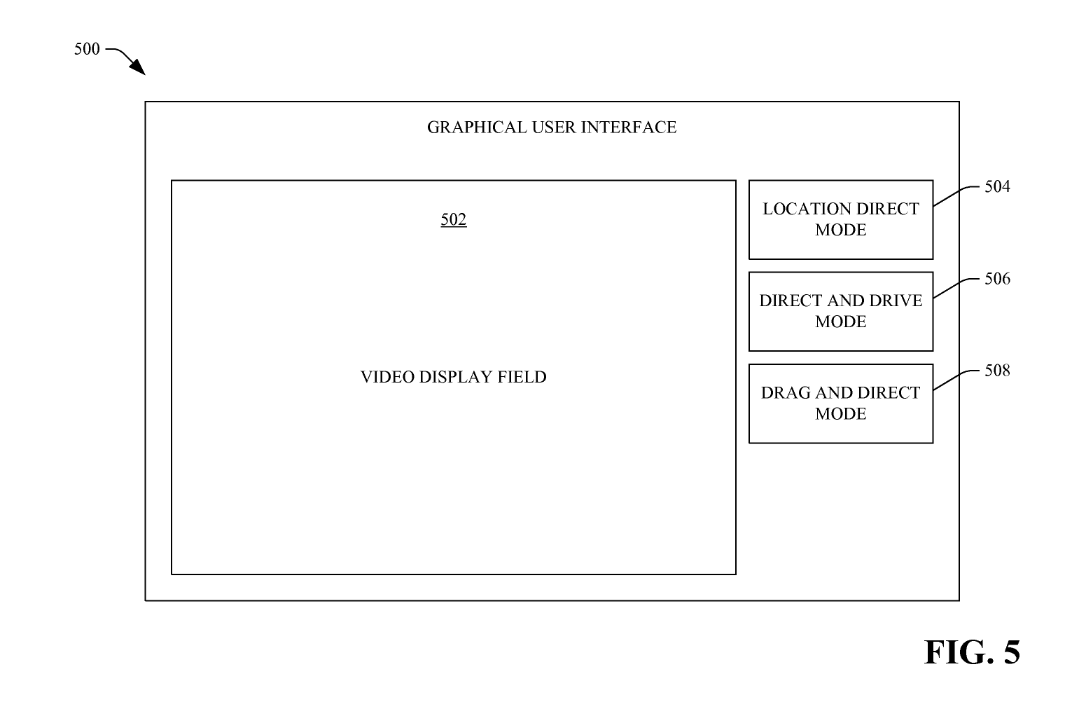

Now referring to FIG. 5, an exemplary graphical user interface 500 is illustrated. The graphical user interface 500 includes a video display field 502 that displays a real-time (live) video feed that is captured by the video camera 112 on the robot 100. The video display field 502 can be interacted with by the user 208 such that the user 208 can click on particular portions of video displayed in the video display field 502, can drag the video in the video display field 502, etc.

The graphical user interface 500 further comprises a plurality of selectable graphical buttons 504, 506, and 508. The first graphical button 504 can cause the graphical user interface 500 to allow the user to interact with the robot 100 in the “location direct” mode described above. Depression of the second graphical button 506 can allow the user 208 to interact with the graphical user interface 500 to direct the robot in the “direct and drive” navigation mode. The third graphical button 508 can cause the graphical user interface 500 to be configured to allow the user 208 to navigate the robot in “drag and direct” mode. While the graphical user interface 500 shows a plurality of graphical buttons 504-508, it is to be understood that there may be no need to display such buttons 504-508 to the user 208, as a navigation mode desired by the user can be inferred based upon a manner in which the user interacts with video shown in the video display field 502.

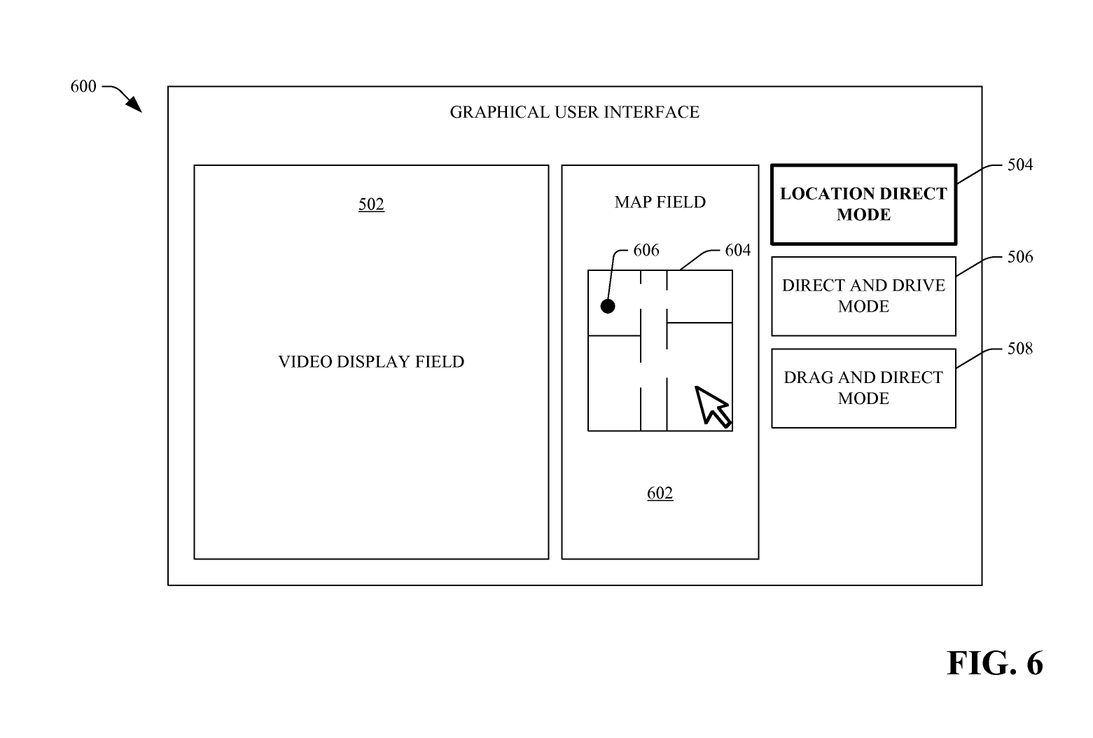

With reference now to FIG. 6, another exemplary graphical user interface 600 is illustrated. The graphical user interface 600 comprises the video display field 502 and the plurality of buttons 504-508. In this exemplary graphical user interface 600, the user 208 has selected the first graphical button 504 to indicate that the user 208 wishes to navigate the robot in the “location direct” mode. For instance, depression of the first graphical button 504 can cause a map field 602 to be included in the graphical user interface 600. In this example the map field, 602 can include a map 604 of the environment of the robot 100. The map 604 can include an indication 606 of a current location of the robot 100. Also, while not shown, the map 604 can include a plurality of tagged locations that can be shown for instance, as hyperlinks, images, etc. Additionally or alternatively, the graphical user interface 600 can include a field (not shown) that includes a list of tagged locations. The tagged locations may be, for instance, names of rooms in the map 604, names of the items that are in locations shown in the map 604, etc. The user 208 can select a tagged location from a list of tagged locations, can select a tagged location that is shown in the map 604, and/or can select an untagged location in the map 604. Selection of the tagged location or the location on the map 604 can cause commands to be sent to the robot 100 to travel to the appropriate location. In another embodiment, the map 604 can be presented as images of the environment of the robot 100 as captured by the video camera 112 (or other camera included in the robot 100). Accordingly, the user can be presented with a collection of images pertaining to different areas of the environment of the robot 100, and can cause the robot to travel to a certain area by selecting a particular image.

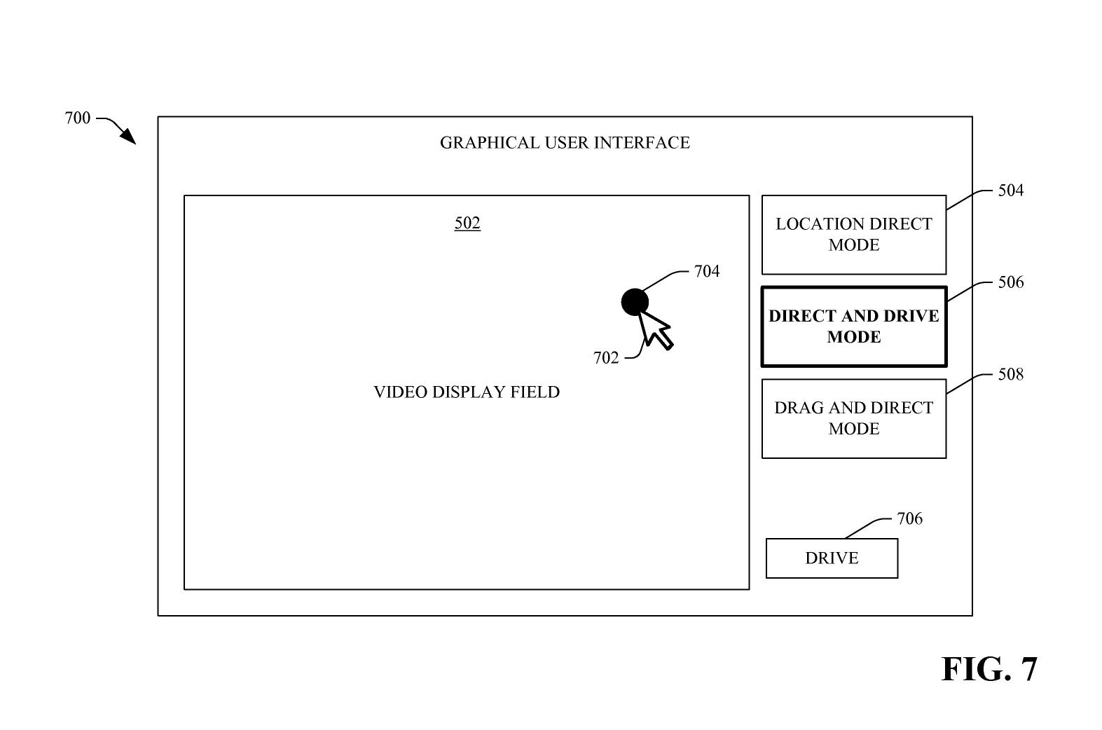

Now turning to FIG. 7, another exemplary graphical user interface 700 that can be utilized in connection with causing the robot 100 to navigate in a particular mode is illustrated. The graphical user interface 700 includes the video display field 502 that displays video data captured by the robot in real-time. In this exemplary graphical user interface 700, the user 208 has selected the second graphical button 506 that can cause the graphical user interface 700 to support navigating the robot 100 in the “direct and drive” mode. The current point of view of the video camera 112 is capturing video at a first point of view. The user 208 can utilize a cursor 702, for instance, to select a particular point 704 in the video feed presented in the video display field 502. Selection of the point 704 in the video feed can initiate transmittal of a command to the robot 100 that causes the video camera 112 on the robot 100 to center upon the selected point 704. Additionally, upon selection of the second graphical button 506, a drive button 706 can be presented to the user 208, wherein depression of the drive button 706 can cause a command to be output to the robot 100 that indicates that the user 208 wishes for the robot 100 to drive in the direction that the video camera is pointing.

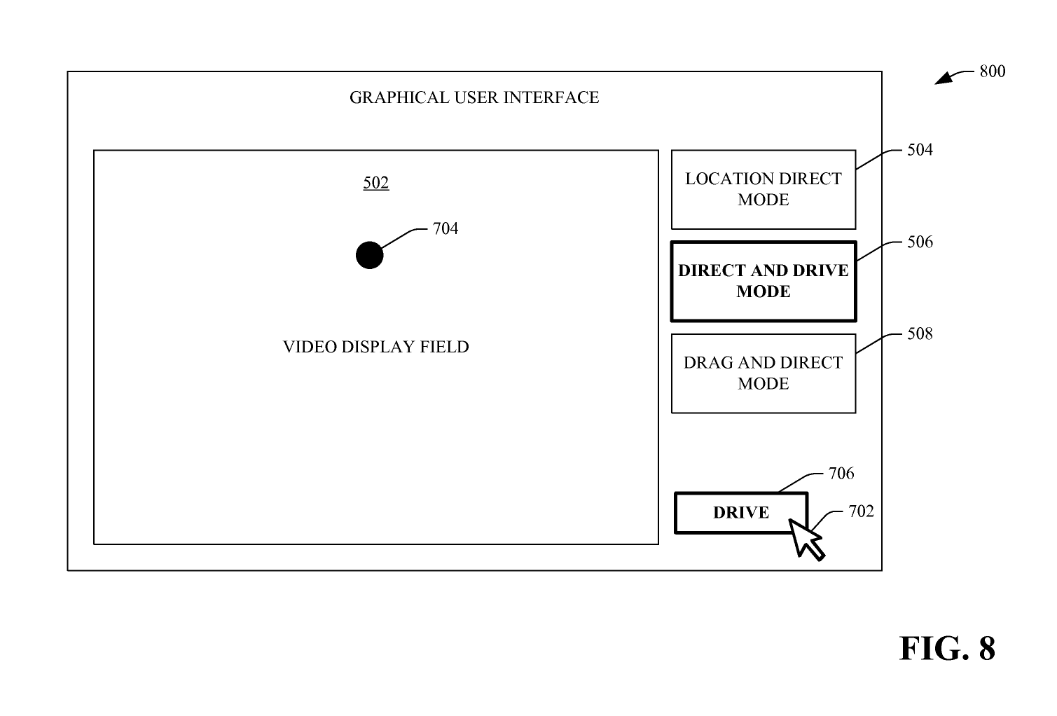

With reference now to FIG. 8, another exemplary graphical user interface 800 that facilitates navigating a robot in “direct and drive” mode is illustrated. As can be ascertained, in the video display field 502, point 704 selected by the user 208 has moved from a right-hand portion of the video display field 502 to a center of the video display field 502. Thus, the video camera 112 in the robot 100 has moved such that the point 704 is now in the center of view of the video camera 112. The user 208 can then select the drive button 706 with the cursor 702, which causes a command to be sent to the robot 100 to travel in the direction that corresponds to the point of view being seen by the user 208 in the video display field 502.

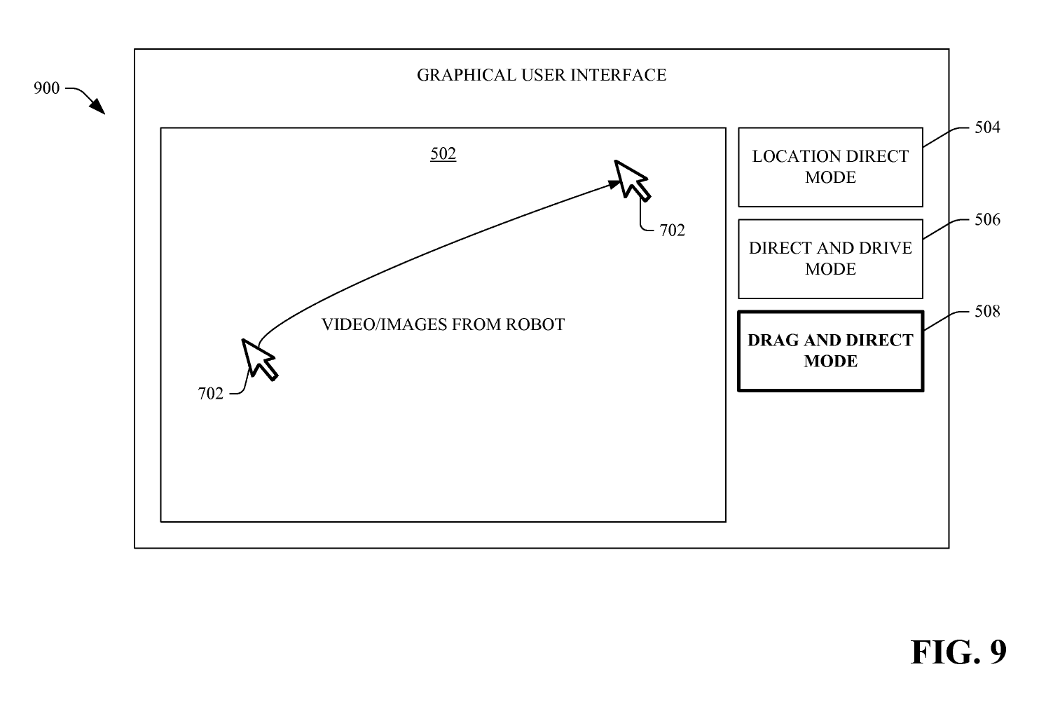

Now turning to FIG. 9 an exemplary graphical user interface 900 that facilitates navigating the robot 100 in “drag and drive” mode is illustrated. The user 208 can select the third graphical button 508, which causes the graphical user interface to enter “drag and direct” mode. The video display field 502 depicts a live video feed from the robot 100, and the user 208, for instance, can employ the cursor 702 to initially select a first position in the video shown in the video display field 502 and drag the cursor to a second position in the video display field 502.

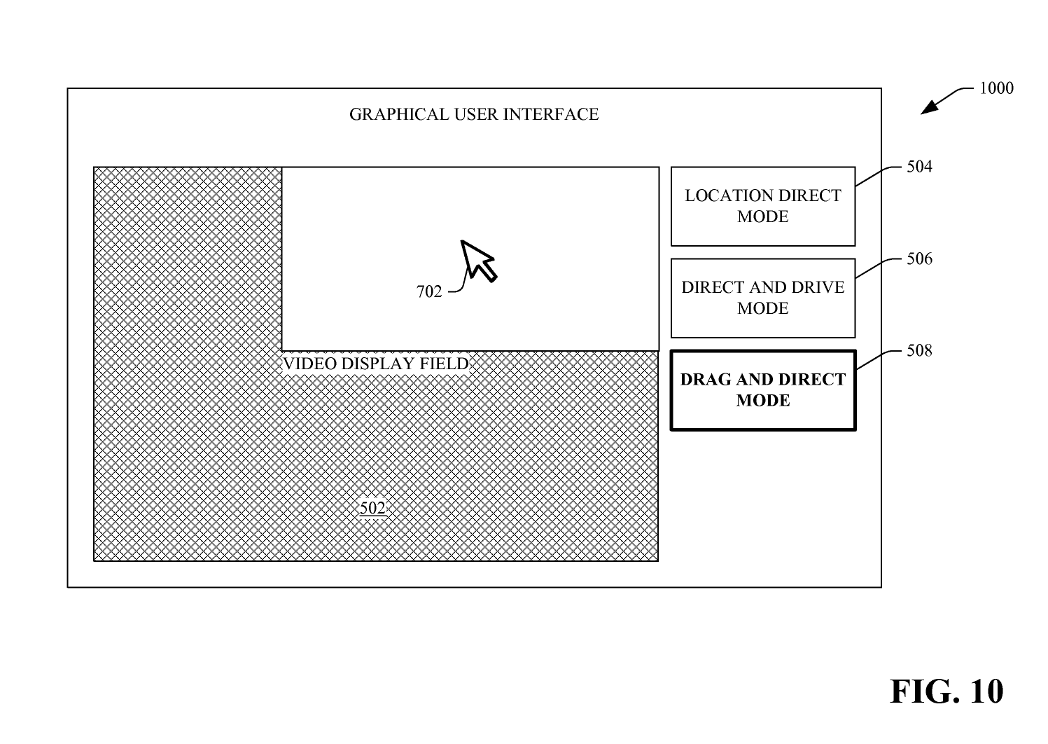

With reference now to FIG. 10, another exemplary graphical user interface 1000 is illustrated. The exemplary graphical user interface 1000 includes the video display field 502, which is shown subsequent to the user 208 selecting and dragging the video presented in the video display field 502. As indicated previously, selection and dragging of the video shown in the video display field 502 can cause commands to be sent to the robot 1000 to alter the position of the video camera 112 at a speed and direction that corresponds to the selection and dragging of the video in the video display field 502. However, the video camera 112 may not be able to be repositioned at a speed that corresponds to the speed of the drag of the cursor 702 made by the user 208. Therefore, portions of the video display field 502 that are unable to show video corresponding to the selection and dragging of the video are grayed out. As the video camera 112 is repositioned to correspond to the final location of the select and drag, the grayed out area in the video display field 502 will be reduced as the video camera 112 in the robot 100 is repositioned.

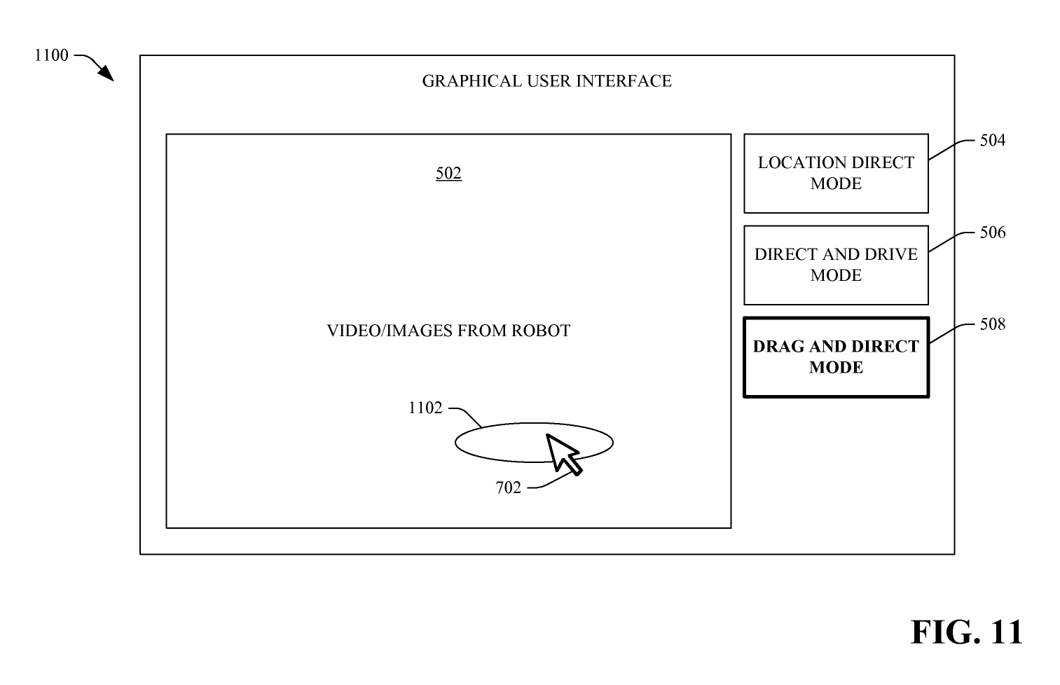

Now turning to FIG. 11, another exemplary graphical user interface 1100 is illustrated. In this example, the user 208 hovers the cursor 702 over a particular portion of the video shown in the video display field 502. The user 208 selects the third graphical button 508 to cause the graphical user interface 1100 to support “drag and direct” mode. Hovering over the cursor 702 in a video shown in the video display field 502 causes a three-dimensional spot 1102 to be presented in the video display field 502. The user 208 may then select the three-dimensional spot 1102 in the video display field 502, which can cause a command to be transmitted to the robot 100 that causes the robot 100 to autonomously travel to the location selected by the user 208.

While the exemplary graphical user interfaces 500-1100 have been presented as including particular buttons and being shown in a certain arrangement, it is to be understood that any suitable graphical user interface that facilitates causing a robot to navigate in either or all of the described navigation modes is contemplated by the inventors and is intended to fall under the scope of the hereto-appended claims.

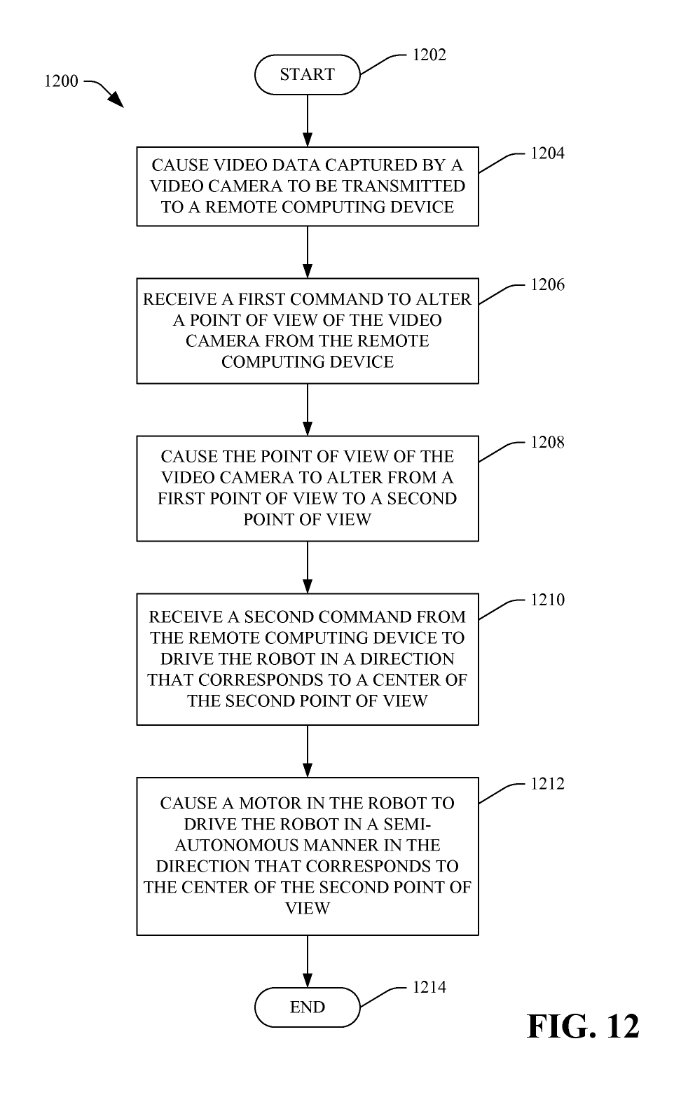

With reference now to FIGS. 12-16, various exemplary methodologies and control flow diagrams (collectively referred to as “methodologies”) are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

With reference now to FIG. 12, an exemplary methodology 1200 that facilitates causing a robot to operate in “direct and drive” mode is illustrated. The methodology 1200 starts at 1202, and at 1204 video data captured by a video camera residing on a robot is transmitted to a remote computing device by way of a communications channel that is established between the robot and the remote computing device. The video camera is capturing video at a first point of view.

At 1206, a first command is received from the remote computing device by way of the communications channel, wherein the first command is configured to alter a point of view of the video camera from the first point of view to a second point of view.

At 1208, responsive to receiving the first command, the point of view of the video camera is caused to be altered from the first point of view to the second point of view. The video camera continues to transmit a live video feed to the remote computing device while the point of view of the video camera is being altered.

At 1210, subsequent to the point of view being changed from the first point of view to the second point of view, a second command is received from the remote computing device by way of the communications channel to drive the robot in a direction that corresponds to a center of the second point of view. In other words, a command is received that request that the robot drive forward from the perspective of the video camera on the robot.

At 1212, a motor in the robot is caused to drive the robot in a direction that corresponds to the center of the second point of view in a semi-autonomous manner. The robot can continue to drive in this direction until one of the following occurs: 1) data is received from a sensor on the robot that indicates that the robot is unable to continue traveling in the direction that corresponds to the center of the second point of view; 2) an indication is received that the user no longer wishes to cause the robot to drive forward in that direction; or 3) the communications channel between the robot and the remote computing devise is disrupted/severed. If it is determined that an obstacle exists in the path of the robot, the robot can autonomously change direction while maintaining the relative position of the camera to the body of the robot. Therefore, if the camera is pointed due north, the robot will travel due north. If an obstacle causes the robot to change direction, the video camera can continue to point due north. Once the robot is able to avoid the obstacle, the robot can continue traveling due north (parallel to the previous path taken by the robot). The methodology 1200 completes at 1214. In an alternative embodiment, the video camera can remain aligned with the direction of travel of the robot. In such an embodiment, the robot can drive in a direction that corresponds to the point of view of the camera, which may be non-identical from an original heading.

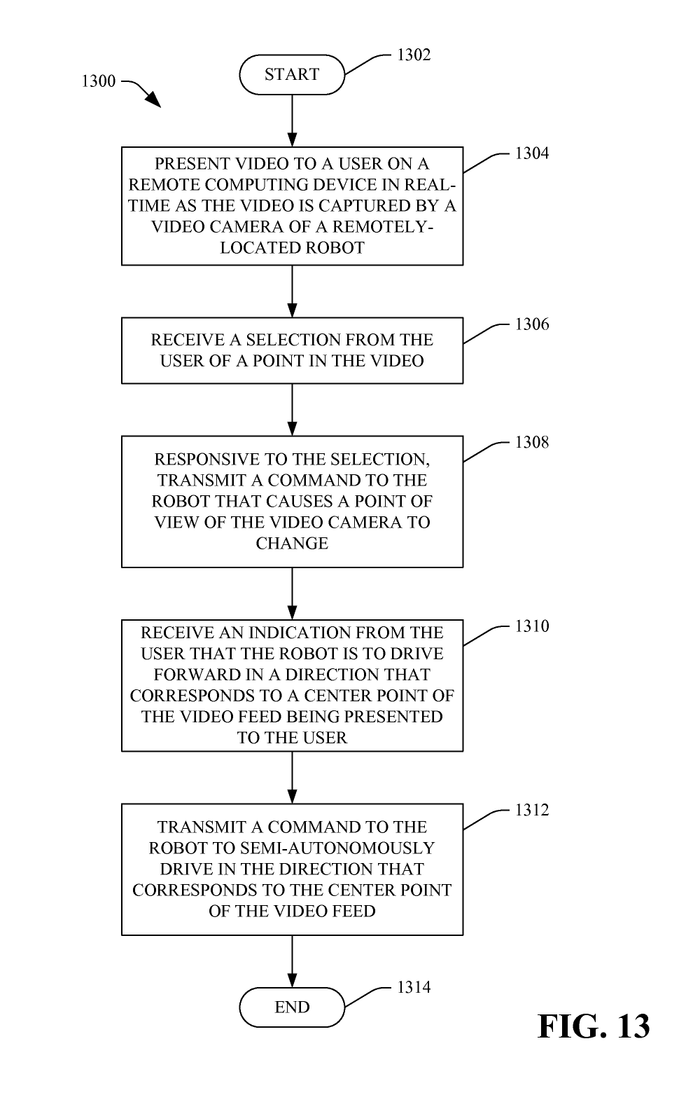

Referring now to FIG. 13, an exemplary methodology 1300 that facilitates causing a robot to navigate in the “direct and drive” mode is illustrated. For instance, the methodology 1300 can be executed on a computing device that is remote from the robot but is in communication with the robot by way of a network connection. The methodology 1300 starts at 1302, and a 1304 video is presented to the user on the remote computing device in real-time as such video is captured by a video camera on a remotely located robot. This video can be presented on a display screen and the user can interact with such video.

At 1306, a selection from the user of a particular point in the video being presented to such user is received. For instance, the user can make such selection through utilization of a cursor, a gesture, a spoken command, etc.

At 1308, responsive to the selection, a command can be transmitted to the robot that causes a point of view of the video camera on the robot to change. For instance, the point of view can change from an original point of view to a point of view that corresponds to the selection of a live video feed of the user, such that the point selected by the user becomes a center point of the point of view of the camera.

At 1310, an indication is received from the user that the robot is to drive forward in a direction that corresponds to a center point of the video feed that is being presented to the user. For example, a user can issue a voice command, can depress a particular graphical button, etc. to cause the robot to drive forward.

At 1312, a command is transmitted from the remote computing device to the robot to cause the robot to drive in the forward direction in a semi-autonomous manner. If the robot encounters an obstacle, the robot can autonomously avoid such obstacle so long as the user continues to drive the robot forward. The methodology, 1300 completes at 1314.

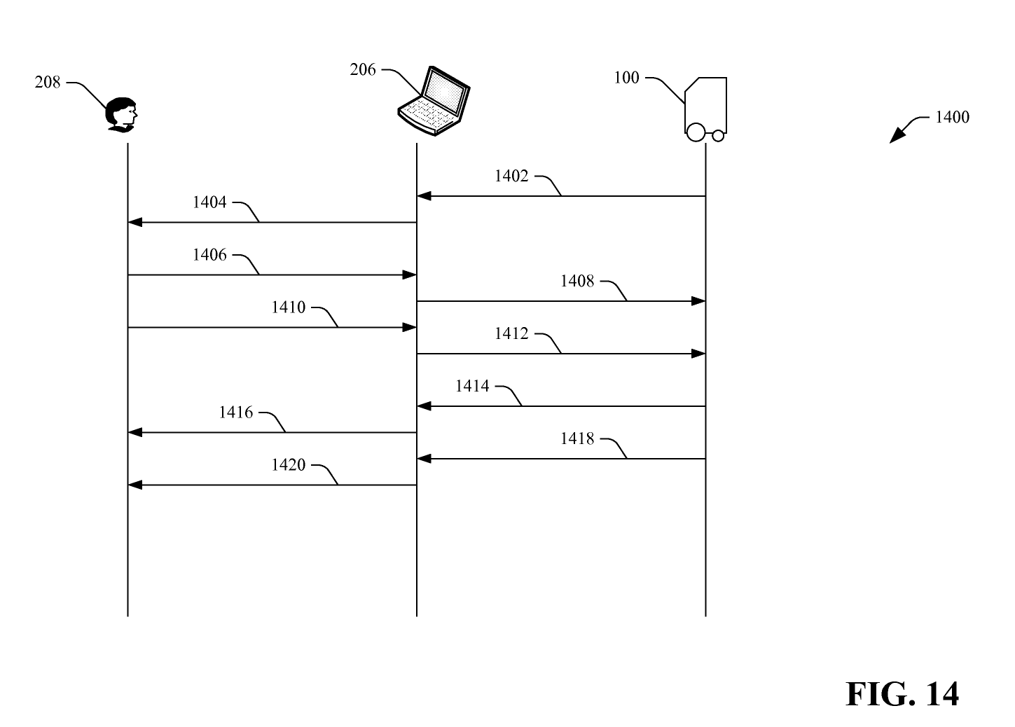

Referring now to FIG. 14, an exemplary control flow diagram 1400 that illustrates the interaction of the user 208, the remote computing device 206, and the robot 100 in connection with causing the robot 100 to explore an environment is illustrated. The control flow diagram 1400 commences subsequent to a telepresence session being established between the robot 100 and the remote computing device 206.

At 1402, subsequent to the telepresence session being established, a map in the memory of the robot 100 is transmitted from the robot 100 to the remote computing device 206. At 1404, such map is displayed to the user 208 on a display screen of the remote computing device 206. The user 208 can review the map and select a tagged location or a particular untagged location in the map, and at 1406 such selection is transmitted to the remote computing device 206. At 1408, the remote computing device 206 transmits the user selection of the tagged location or untagged location in the map to the robot 100. At 1410, an indication is received from the user 208 at the remote computing device 206 that the user 208 wishes for the robot 100 to begin navigating to the location that was previously selected by the user 208. At 1412, the remote computing device 206 transmits a command to the robot 100 to begin navigating to the selected location. At 1414, the robot 100 transmits a status update to the remote computing device 206, wherein the status update can indicate that navigation is in progress. At 1416, the remote computing device 206 can display the navigation status to the user 208, and the robot 100 can continue to output the status of navigating such that it can be continuously presented to the user 208 while the robot 100 is navigating to the selected location. Once the robot 100 has reached the location selected by the user 208, the robot 100 at 1418 can output an indication that navigation is complete. This status is received at the remote computing device 206, which can display this data to the user 208 at 1420 to inform the user 208 that the robot 100 has completed navigation to the selected location.

If the user 208 indicates that she wishes that the robot 100 will go to a different location after the robot 100 has begun to navigate, then a location selection can again be provided to the robot 100 by way of the remote computing device 206. This can cause the robot 100 to change course from the previously selected location to the newly selected location.

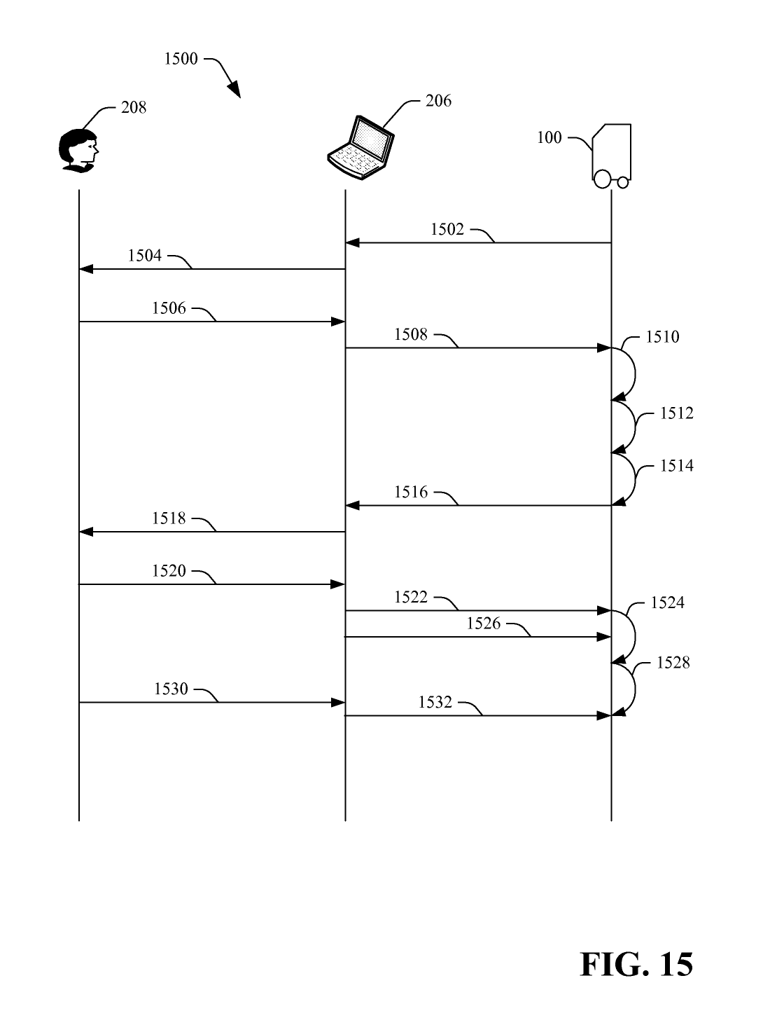

Now referring to FIG. 15, another exemplary control flow diagram 1500 that illustrates interaction between the user 208, the remote computing device 206, and the robot 100 when the user 208 wishes to cause the robot 100 to navigate in “direct and drive” mode is illustrated. At 1502, video captured at the robot 100 is transmitted to the remote computing device 206. This video is from a current point of view of the video camera on the robot 100. The remote computing device 206 then displays the video at 1504 to the user 208. At 1506, the user selects in the live video feed a point using a click, a touch, or a gesture, wherein this click, touch, or gesture is received at the remote computing device 206. At 1508, the remote computing device 206 transmits coordinates of the user selection to the robot 100. These coordinates can be screen coordinates or can be coordinates in a global coordinate system that can be interpreted by the robot 100. At 1510, pursuant to an example, the robot 100 can translate the coordinates. These coordinates are translated to center the robot point of view (the point of view of the video camera) on the location selected by the user in the live video feed. At 1512, the robot 100 compares the new point of view to the current point of view. Based at least in part upon this comparison, at 1514 the robot 100 causes the video camera to be moved to the center of the point of view. At 1516, video is transmitted from the robot 100 to the remote computing device 206 to reflect the new point of view.

At 1518, the remote computing device 206 displays this video feed to the user 208 as a live video feed. At 1520, the user 208 indicates her desire to cause a robot 100 to drive in a direction that corresponds to the new point of view. At 1522, the remote computing device 206 transmits a command that causes the robot 100 to drive forward (in a direction that corresponds to the current point of view of the video camera on the robot). At 1524, in accordance with the command received at 1522, the robot 100 adjusts its drive train such that the drive train position matches the point of view of the video camera. At 1526, the remote computing device 206 transmits transmit heartbeats to the robot 100 to indicate that the user 208 continues to wish that the robot 100 drive forward (in a direction that corresponds to the point of view of the video camera). At 1528, the robot 100 drives forward using its navigation system (autonomously avoiding obstacles) so long as heartbeats are received from the remote computing device 206. At 1530, for instance, the user 208 can release the control that causes the robot 100 to continue to drive forward, and that 1532 the remote computing device 206 ceases to transmit heartbeats to the robot 100. The robot 100 can detect that a heartbeat has not been received and can therefore cease driving forward immediately subsequent to 1532.

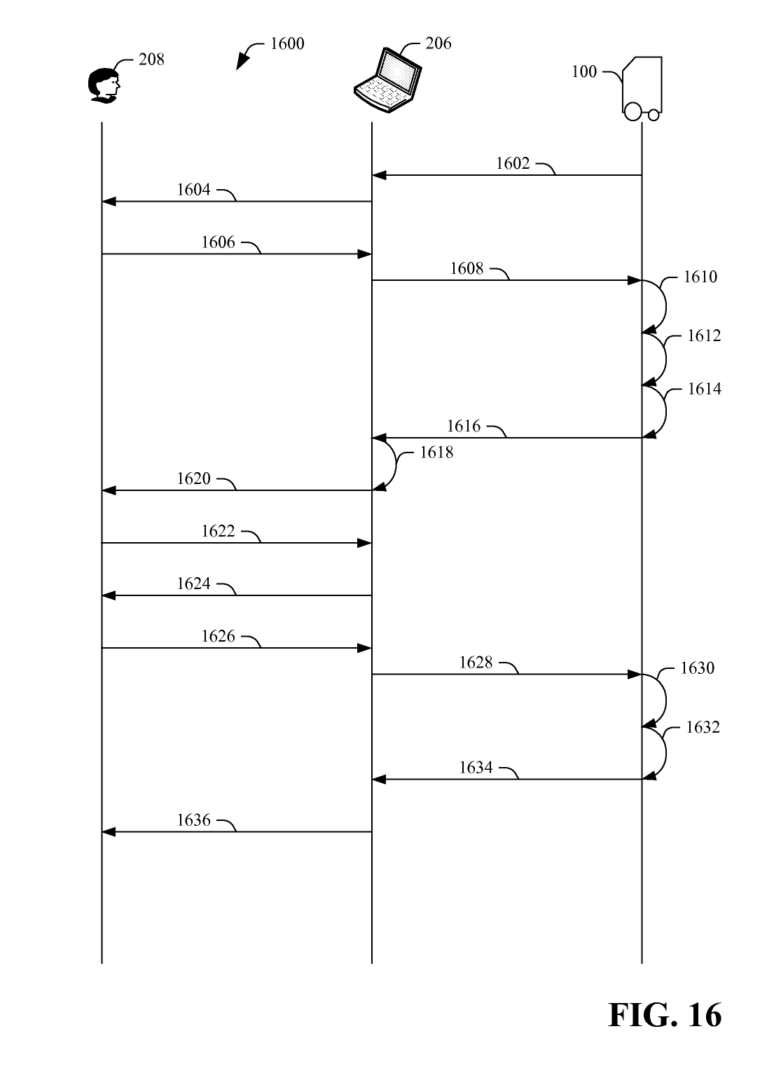

Referring now to FIG. 16, another exemplary control flow diagram 1600 is illustrated. The control flow diagram 1600 illustrates interactions between the user 208, the remote computing device 206, and the robot 100 subsequent to a telepresence session being established and further indicates interactions between such user 208, remote computing device 206, and robot 100 when the user 208 wishes to direct the robot 108 in the “drag and direct” navigation mode. At 1602, the robot 100 transmits video to the remote computing device 206 (live video). At 1604 the remote computing device 206 displays the live video feed captured by the robot 100 to the user 208. At 1606, the user 208 can select, for instance, through use of a cursor, the live video feed and drag the live video feed. At 1608, the remote computing device 206 transmits data pertaining to the selection and dragging of the live video feed presented to the user 208 on the remote computing device 206. At 1610, the robot 100 can translate coordinates in a coordinate system that can be utilized to update the position of the video camera with respect to the environment that includes the robot 100.

At 1612, the previous camera position can be compared with the new camera position. At 1614, the robot 100 can cause the position of the video camera to change in accordance with the dragging of the live video feed by the user 208. At 1616, the robot 100 continues to transmit video to remote computing device 206.

At 1618, the remote computing device 206 updates a manner in which the video is displayed. For example, the user 208 may wish to control the video camera of the robot 100 as if the user 208 were controlling here own eyes. However, the video camera on the robot 100 may not be able to be moved as quickly as desired by the user 208. The perception of movement still may be desired by the user 208. Therefore, the remote computing device 206 can format a display of the video such that the movement of the video camera on the robot 100 is appropriately depicted to the user 208. For example, upon the user 208 quickly dragging the video feed, initially the remote computing device 206 can cause portions of video to be grayed out since the video camera on the robot 100 is unable to capture that area that is desirably seen by the user 208. As the video camera on the robot 100 is repositioned, however, the grayed out area shown to the user can be filled. At 1620, video is displayed to the user 208 in a manner such as that just described.

At 1622, the user 208 hovers a cursor over a particular location in the live video feed. At 1624, a three-dimensional spot is displayed to the user 208 in the video. The remote computing device 206 can calculate where and how to display the three-dimensional spot based at least in part upon the pitch and height of the video camera on the robot 100. At 1626, the user 208 selects a particular spot, and at 1628 the remote computing device 206 transmits such selection in the form of coordinates to the robot 100. At 1630, the robot 100 adjusts its drivetrain to point towards the spot that was selected by the user 208. At 1632, the robot 100 autonomously drives to that location while transmitting status updates to the user 208 via the remote computing device 206. Specifically, at 1634, after the robot 100 has reached the intended destination, the robot 100 can transmit a status update to the remote computing device 206 to indicate that the robot 100 has reached its intended destination. At 1636, the remote computing device 206 can transmit the status update to the user 208.

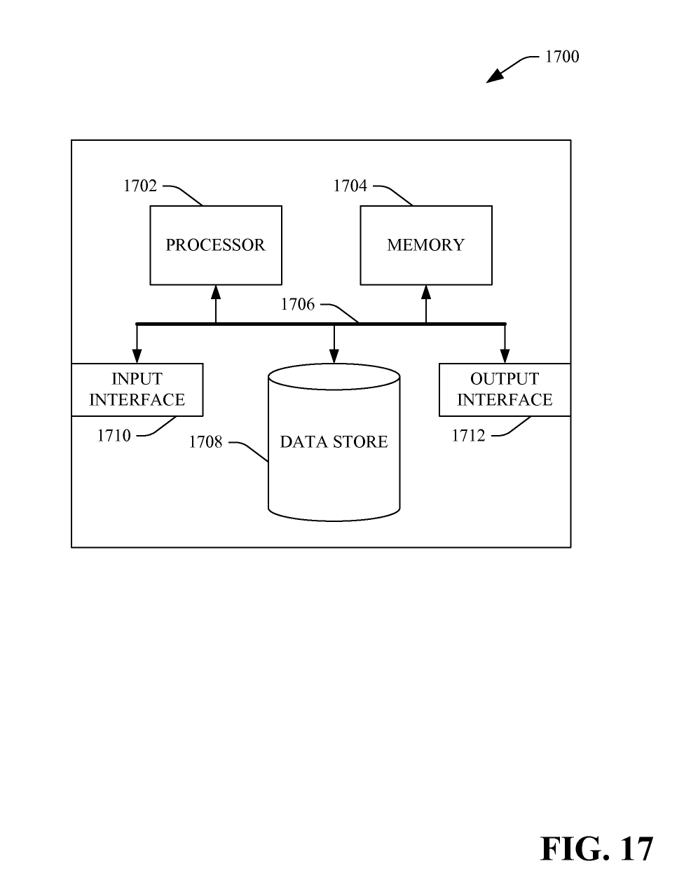

Now referring to FIG. 17, a high-level illustration of an exemplary computing device 1700 that can be used in accordance with the systems and methodologies disclosed herein is illustrated. For instance, the computing device 1700 may be used in a system that supports transmitting commands to a robot that causes the robot to navigate semi-autonomously in one of at least three different navigation modes. In another example, at least a portion of the computing device 1700 may be resident in the robot. The computing device 1700 includes at least one processor 1702 that executes instructions that are stored in a memory 1704. The memory 1704 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 1702 may access the memory 1704 by way of a system bus 1706. In addition to storing executable instructions, the memory 1704 may also store a map of an environment of a robot, list of tagged locations, images, data captured by sensors, etc.

The computing device 1700 additionally includes a data store 1708 that is accessible by the processor 1702 by way of the system bus 1706. The data store 1708 may be or include any suitable computer-readable storage, including a hard disk, memory, etc. The data store 1708 may include executable instructions, images, audio files, etc. The computing device 1700 also includes an input interface 1710 that allows external devices to communicate with the computing device 1700. For instance, the input interface 1710 may be used to receive instructions from an external computer device, a user, etc. The computing device 1700 also includes an output interface 1712 that interfaces the computing device 1700 with one or more external devices. For example, the computing device 1700 may display text, images, etc. by way of the output interface 1712.

Additionally, while illustrated as a single system, it is to be understood that the computing device 1700 may be a distributed system. Thus, for instance, several devices may be in communication by way of a network connection and may collectively perform tasks described as being performed by the computing device 1700.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method that is executable by a processor residing in a mobile robot, the method comprising:
causing video data captured by a video camera resident upon the robot to be transmitted to a remote computing device by way of a communications channel established between the robot and the remote computing device, wherein the video camera is capturing video data at a first point of view;
receiving a first command by way of the communications channel from the remote computing device to alter a point of view of the video camera from the first point of view to a second point of view;
responsive to receiving the first command, causing the point of view of the video camera to be altered from the first point of view to the second point of view while continuing to transmit video data to the remote computing device by way of the communications channel;
subsequent to the point of view of the robot being altered from the first point of view to the second point of view, receiving a second command by way of the communications channel to drive the robot in a direction that corresponds to a center of the second point of view;
causing a motor to drive the robot in the direction that corresponds to the second point of view until either 1) a command is received from the remote computing device to discontinue driving the robot in the direction that corresponds to the center of the second point of view; or 2) data is received from a sensor on the robot that indicates that the robot is unable to continue travelling in the direction that corresponds to the center of the second point of view, wherein the robot travels autonomously in the direction that corresponds to the second point of view.

2. The method of claim 1, wherein the communications channel established between the robot and the remote computing device is over the Internet.

3. The method of claim 1, wherein the communications channel established between the robot and the remote computing device is over a cellular telephone network.

4. The method of claim 1, wherein the video camera is moveable by a different motor than the motor utilized to drive the robot.

5. The method of claim 1, further comprising:
receiving the command from the remote computing device to discontinue driving the robot in the direction that corresponds to the center of the second point of view, wherein the command identifies a predefined location; and
causing the robot to autonomously travel to the predefined location.

6. The method of claim 1, further comprising:
receiving the command from the remote computing device to discontinue driving the robot in the direction that corresponds to the center of the second point of view, wherein the command identifies a particular location that is in the second point of view of the video camera; and
causing the robot to autonomously travel to the location in the second point of view of the video camera.

7. The method of claim 1, wherein the sensor in the robot is an infrared depth sensor.

8. The method of claim 1, further comprising:
receiving a third command from the remote computing device to alter the point of view of the video camera from the second point of view to a third point of view; and
responsive to receiving the third command, causing the point of view of the video camera to be changed from the second point of view to the third point of view; and
causing the motor to drive the robot in another direction that corresponds to a center of the third point of view.

9. The method of claim 1, further comprising causing a display on the robot to display data pertaining to the second command on a display of the robot while the robot is travelling in the direction that corresponds to the center of the second point of view.

10. The method of claim 1, further comprising:
receiving data from the sensor on the robot that indicates that the robot is unable to continue travelling in the direction that corresponds to the center of the second point of view, wherein the data from the sensor indicates existence of an obstacle in the direction that corresponds to the center of the second point of view; and
automatically causing a travel direction of the robot to alter to a new travel direction to avoid the obstacle.

11. The method of claim 10, further comprising:
receiving data from the sensor on the robot that indicates that the obstacle has been passed by the robot; and
automatically causing the travel direction of the robot to alter such that the robot travels in the direction that corresponds to the center of the second point of view.

12. A robot, comprising:
a processor; and
a memory, wherein the memory comprises a plurality of components that are executable by the processor, the components comprising:
a direct and drive component that is configured to direct the robot along a path in a first direction based at least in part upon commands received from a remote computing device, wherein the remote computing device is in communication with the robot by way of a network, wherein the commands comprise:
a first command that causes the direct and drive component to change a point of view of a video camera on the robot to change from a first point of view to a second point of view; and
a second command that causes the direct and drive component to drive the robot to drive along the path in the first direction subsequent to the point of view of the video camera changing from the first point of view to the second point of view, wherein the first direction corresponds to a center point of the second point of view;
an obstacle detector component that receives data from a sensor that indicates that an obstacle resides in the path of the robot and outputs an indication that the obstacle resides in the path of the robot; and
a direction modifier component that receives the indication, and responsive to receipt of the indication, causes the robot to automatically change direction from the first direction to a second direction to avoid the obstacle.

13. The robot of claim 12, wherein the network is the Internet.

14. The robot of claim 12, wherein the robot is configured to receive the commands from a mobile computing device.

15. The robot of claim 12, wherein the components further comprise an audio/video transmitter component that is configured to transmit live audio/video captured from the video camera in the robot to the remote computing device.

16. The robot of claim 12, wherein the memory further comprises a map of an environment, wherein the map of the environment comprises a plurality of tagged locations, and wherein the plurality of components further comprise:
a location direction component that receives a third command that comprises an indication of a selection of a tagged location from amongst the plurality of tagged locations in the map in the memory of the robot, wherein the location direction component causes the robot to travel from a current position to the tagged location, wherein the obstacle detector component receives second data from the sensor that indicates that another obstacle is in a path taken by the robot to reach the tagged location, and wherein the direction modifier component causes the robot to autonomously avoid the obstacle and reaching the tagged location.

17. The robot of claim 16, wherein the robot is configured to output data on a display of the robot to indicate the location to which the robot is travelling.

18. The robot of claim 12, wherein the plurality of components further comprise:
a drag and direct component that is configured to direct the robot to a particular specified location that is in a portion of video captured by the video camera based at least in part upon additional commands received from the remote computing device, wherein the additional commands comprises:
a third command that causes the point of view of the video camera to change from the second point of view to a third point of view; and
a fourth command that specifies a particular location in the third point of view of the video camera subsequent to the point of view of the video camera changing from the third point of view to the fourth point of view, wherein the obstacle, wherein detector component receives second data from the sensor that indicates that another obstacle resides between the robot and the specified location, and wherein the direction modifier component causes the robot to autonomously avoid the obstacle and reach the specified location.

19. The robot of claim 12, wherein the direct and drive component causes the point of view of the video camera to change from the first point of view to the second point of view without altering an orientation of a body of the robot.

20. A robot, comprising:
a processor; and
a memory that comprises a plurality of components that are executable by the processor, wherein the plurality of components comprises:
a drive and direct component that is configured to drive a robot in a direction specified by way of a first command from a remote computing device, wherein the drive and direct component is configured to autonomously cause the robot to avoid obstacles while driving in the direction specified in the first command;
a location direction component that is configured to drive the robot to a tagged location in a map of an environment that is being experienced by the robot, wherein the map is retained in the memory of the processor, wherein the location direction component is configured to drive the robot to the tagged location responsive to receipt of a second command from the remote computing device, wherein the second command indicates the tagged location,
and wherein the location direction component is configured to autonomously cause the robot to avoid obstacles while driving to the tagged location; and
a drag and direct component that is configured to drive the robot to a particular location that is in a field of view of a video camera in the robot responsive to a third command from the remote computing device, wherein the third command indicates the location in the field of view of the video camera, and wherein the drag and direct component is configured to autonomously cause the robot to avoid obstacles while driving to the particular location.
